(19) United States
(12) Patent Application Publication
(10) Pub. No.: US 2009/0228733 A1
(43) Pub. Date: Sep. 10, 2009

(54) Power Management On sRIO Endpoint

(75) Inventor: Chi-Lie Wang, Milpitas, CA (US)

Correspondence Address: BEVER, HOFFMAN & HARMS, LLP, 1730 HOLMES STREET, BUILDING B, LIVERMORE, CA, 94550, US

(73) Assignee: INTEGRATED DEVICE TECHNOLOGY, INC., San Jose, CA (US)

(21) Appl. No.: 12/043,940

(22) Filed: Mar. 6, 2008

(51) Int. Cl. G06F 1/10; G06F 1/04

(52) U.S. Cl. 713/500; 713/601

(57) ABSTRACT

Clock signals used to operate core receive logic and core transmit logic within a serial buffer are dynamically enabled and disabled to minimize power consumption. A physical layer interface and an event monitor are continuously enabled to identify the start of incoming transactions. Upon detecting the start of an incoming transaction, the event monitor activates a packet retry signal, and also initiates generation of a receive clock signal within the serial buffer. By the time that the incoming transaction is re-sent, the receive clock signal is enabled, thereby enabling the associated core receive logic. Once enabled, the receive clock signal remains enabled until the period between consecutive incoming transactions exceeds a timeout period, whereupon the receive clock signal is disabled. A similar mechanism is provided to dynamically enable and disable a transmit clock signal, which enables and disables corresponding core transmit logic of the serial buffer.

### RELATED APPLICATIONS

The present application is related to, and incorporates by reference, the following commonly owned, co-filed U.S. patent applications: Ser. No. 12/043,918 filed by Chi-Lie Wang and Jason Z. Mo on Mar. 6, 2008, entitled “Method To Support Flexible Data Transport On Serial Protocols”; Ser. No. 12/043,929 also filed by Chi-Lie Wang and Jason Z. Mo on Mar. 6, 2008, entitled “Protocol Translation In A Serial Buffer”; Ser. No. 12/043,934 filed by Chi-Lie Wang and Jason Z. Mo on Mar. 6, 2008, entitled “Serial Buffer To Support Reliable Connection Between Rapid I/O End-Point And FPGA Lite-Weight Protocols”; Ser. No. 12/______ (Docket No. IDT-2274) filed by Chi-Lie Wang and Jason Z. Mo on Mar. 6, 2008, entitled “Serial Buffer To Support Rapid I/O Logic Layer Out Of Order Response With Data Retransmission”; and Ser. No. 12/______ (IDT-2277) filed by Chi-Lie Wang, Jason Z. Mo, Calvin Nguyen and Bertan Tezcan on Mar. 6, 2008, entitled “Method To Support Lossless Real Time Data Sampling And Processing On Rapid I/O End-Point”.

### FIELD OF THE INVENTION

The present invention relates to a serial buffer. More specifically, the present invention relates to a power management system for a serial buffer.

### RELATED ART

A serial buffer typically includes many functional blocks including a memory block, core receive logic, and core transmit logic. The core receive logic typically processes incoming transactions received by the serial buffer. If an incoming transaction requires the storage of information in the memory block, the core receive logic will control the associated write operations to the memory block. The core transmit logic typically controls the outgoing transactions transmitted from the serial buffer. If an outgoing transaction requires the retrieval of information from the memory block, the core transmit logic will perform the associated read operations from the memory block.

The core receive logic and the core transmit logic are constantly enabled during normal operation of a conventional serial buffer, even if the serial buffer is not processing incoming or outgoing transactions. This undesirably results in high power consumption within the serial buffer. It would therefore be desirable to have a method for reducing power consumption in a serial buffer.

### SUMMARY

Accordingly, the present invention provides a power management system for a serial buffer. In one embodiment, the serial buffer is configured to operate as an end-point, in accordance with a serial Rapid I/O (sRIO) protocol. The serial buffer includes a plurality of queues (which can be implemented using either dual-port memory, internal memory or external memory) for temporary buffer storage to support data offload functions. In order to minimize power consumption, if the serial buffer is inactive (i.e., has no pending incoming or outgoing transactions) for an extended time period, then clock signals are only enabled within a small number of blocks within the serial buffer. In accordance with one embodiment, the only blocks of the serial buffer enabled during an extended inactive period include a sRIO physical layer interface and an event monitor. The sRIO physical layer interface allows any incoming sRIO control symbols to be detected and provided to the event monitor. Upon detecting any sRIO control symbol, the event monitor initiates a ‘retry’ operation, which requests that the device transmitting the detected sRIO control symbol re-send the corresponding sRIO transaction. At the same time, the event monitor instructs a clock enable circuit to enable the generation of a receive clock signal, which is used to operate core receive logic within the serial buffer. By the time the originating device re-sends the sRIO transaction (in response to the retry request), the core receive logic within the serial buffer is enabled to process the re-sent sRIO transaction.

After the receive clock signal has been enabled, and the core receive logic detects the end of the re-sent sRIO transaction, an associated receive timer is loaded with a receive timeout value. The receive timer counts down from the receive timeout value until this timer expires or is re-loaded with the receive timeout value. If the core receive logic detects the start of the next incoming transaction before the receive timer expires, then the receive timer is re-loaded. As long as the receive timer does not expire, the receive clock signal remains enabled.

However, if the receive timer expires before the core receive logic detects the start of the next incoming transaction, then the receive clock signal is disabled. In this case, the receive clock signal remains disabled until the next incoming transaction is detected. By operating in this manner, power savings are realized within the core receive logic.

Note that core transmit logic of the serial buffer may remain disabled even after the core receive logic is enabled. However, if any sRIO transactions become active on the transmit side of the serial buffer, the core transmit logic will be enabled. That is, the serial buffer will instruct a clock enable circuit to enable the generation of a transmit clock signal, which is used to operate the core transmit logic. An sRIO transaction may become active on the transmit side, for example, when the water level reaches the water mark within one of the queues, thereby requiring that a data packet be transmitted out of the queue. An sRIO transaction may also become active on the transmit side when the serial buffer is required to transmit a doorbell command or respond to a sRIO request transaction. When the core transmit logic is enabled, the associated information (e.g., data packets, doorbell commands, response packets) can be transmitted from the serial buffer.

After the transmit clock signal has been enabled, and the core transmit logic detects the end of an outgoing transaction, an associated transmit timer is loaded with a transmit timeout value. The transmit timer counts down from the transmit timeout value until this timer expires or is re-loaded with the transmit timeout value. If the core transmit logic detects the start of the next output transaction before the transmit timer expires, then the transmit timer is re-loaded. As long as the transmit timer does not expire, the transmit clock signal remains enabled.

However, if the transmit timer expires before the core transmit logic detects the start of the next outgoing transaction, then the transmit clock signal is disabled. In this case, the transmit clock signal remains disabled until the next outgoing transaction is detected. By operating in this manner, power savings are realized within the core transmit logic.

The present invention will be more fully understood in view of the following description and drawings.

### BRIEF SUMMARY OF THE DRAWINGS

FIG. 1 is a block diagram of a serial buffer that implements a power management system in accordance with one embodiment of the present invention.

FIG. 2 is a flow diagram illustrating the operation of an event monitor present in the serial buffer of FIG. 1 in accordance with one embodiment of the present invention.

FIG. 3 is a flow diagram illustrating the operation of clock enable logic present in the serial buffer of FIG. 1 in accordance with one embodiment of the present invention.

FIG. 4 is a flow diagram illustrating the operation of receive timer logic present in the serial buffer of FIG. 1 in accordance with one embodiment of the present invention.

FIG. 5 is a block diagram of a portion of receive timer logic present in the serial buffer of FIG. 1 in accordance with one embodiment of the present invention.

FIG. 6 is a flow diagram illustrating the operation of transmit timer logic present in the serial buffer of FIG. 1 in accordance with one embodiment of the present invention.

FIG. 7 is a block diagram of a portion of transmit timer logic present in the serial buffer of FIG. 1 in accordance with one embodiment of the present invention.

### DETAILED DESCRIPTION

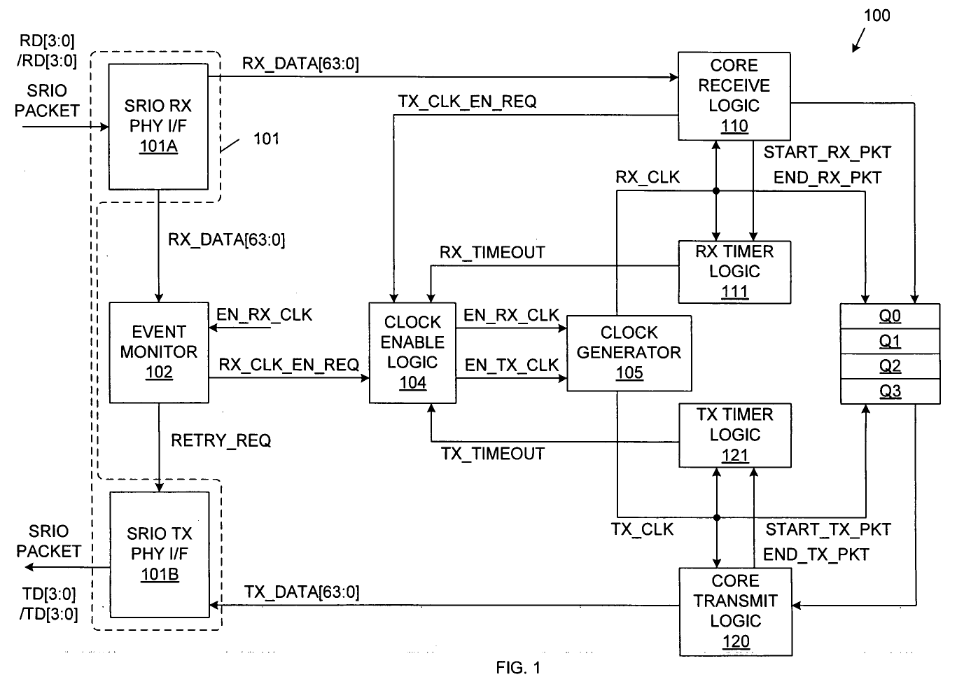

FIG. 1 is a block diagram of a serial buffer 100 in accordance with one embodiment of the present invention. Serial buffer includes sRIO physical layer interface 101, event monitor 102, clock enable logic 104, clock generator 105, core receive logic 110, receive timer logic 111, core transmit logic 120, transmit timer logic 121 and queues Q0-Q3. SRIO physical layer interface 101 includes sRIO physical layer interface (PHY) receive logic 101A and sRIO physical layer interface (PHY) transmit logic 101B.

During normal operation of serial buffer 100 sRIO physical layer interface 101 and event monitor 102 are continuously enabled (i.e., operate in response to an enabled clock signal). In contrast, core receive logic 110 and core transmit logic 120 are disabled by default. More specifically, a receive clock signal RX_CLK used to operate core receive logic 110 and a transmit clock signal TX_CLK used to operate core transmit logic 120 are disabled by default.

In general, sRIO PHY receive logic 101A is configured to receive incoming transactions, which are transmitted to serial buffer 100 by an external device (not shown). These incoming transactions are provided in a sRIO packet format, which includes both a packet header and packet data. The continuously enabled sRIO PHY receive logic 101A is capable of receiving any control signals, including start-of-packet (SOP) control symbols, transmitted from the external device.

The continuously enabled event monitor 102 is configured to detect when sRIO PHY receive logic 101A receives a start-of-packet (SOP) control symbol from the external device. Upon detecting an SOP control symbol (and also determining that core receive logic 110 is currently disabled), event monitor 102 activates a retry request (RETRY_REQ=1) and a receive clock enable request signal (RX_CLK_EN_REQ=1).

The activated retry request (RETRY_REQ) is provided to sRIO PHY transmit logic 101B. In general, sRIO PHY transmit logic 101B is configured to transmit outgoing transactions from serial buffer 100 to the external device. SRIO PHY transmit logic 101B is typically configured to generate IDLE symbols while the core transmit logic 120 is not active. Upon receiving an activated retry request RETRY_REQ from event monitor 102, the continuously enabled sRIO PHY transmit logic 101B generates a packet retry control symbol, which is transmitted to the external device. In response to receiving this packet retry control symbol, the external device will re-send the transaction associated with the SOP control symbol detected by event monitor 102.

The activated receive clock enable request (RX_CLK_EN_REQ) is provided to clock enable logic 104. In response, clock enable logic 104 activates an enable receive clock signal (EN_RX_CLK=1), which causes clock generator 105 to start generating (i.e., activate) the receive clock signal RX_CLK. The active receive clock signal RX_CLK is provided to core receive logic 110, receive timer logic 111 and queues Q0-Q3, thereby enabling these blocks. By the time the re-sent transaction is received by sRIO PHY receive logic 101A, core receive logic 110 will be enabled to service this transaction.

Once enabled, the receive clock RX_CLK will stay enabled until the period between consecutive incoming transactions exceeds a predetermined time period, which is hereinafter referred to as the receive clock timeout period. After servicing an incoming transaction, core receive logic 110 activates a control signal (END_RX_PKT) that indicates the end of the incoming transaction. Upon detecting that the END_RX_PKT signal has been activated, receive timer logic 111 starts counting down from a receive clock timeout value, which defines the receive clock timeout period. In the described embodiment, the receive clock timeout period is measured in cycles of the receive clock signal RX_CLK.

Upon detecting a new incoming transaction, core receive logic 110 activates a control signal (START_RX_PKT) that indicates the start of the incoming transaction. If the next incoming transaction is received (i.e., the START_RX_PKT signal is activated) before receive timer logic 111 expires, then receive timer logic 111 is reset. More specifically, receive timer logic 111 is controlled to start counting down from the receive clock timeout value after the new incoming transaction has been serviced (i.e., when the END_RX_PKT signal is activated).

However, if receive timer logic 111 expires before the next incoming transaction is received, then receive timer logic 111 activates a receive timeout signal (RX_TIMEOUT=1), which disables the receive clock signal RX_CLK. More specifically, the activated receive timeout signal RX_TIMEOUT causes clock enable logic 104 to disable the enable receive clock signal (EN_RX_CLK=0), which in turn, causes clock generator 105 to stop generating the receive clock signal RX_CLK. As a result, core receive logic 110 is returned to its default (disabled) state.

In the described embodiment, core receive logic 110 also determines when core transmit logic 120 must be enabled. For example, if core receive logic 110 receives a request packet, then core receive logic 110 will enable core transmit logic 120 to allow the corresponding response packet to be sent from serial buffer 100. Similarly, if core logic 110 determines that the water level of a queue has reached the water mark of the queue, then core receive logic 110 will enable core transmit logic 120 to allow one or more packets to be retrieved from the queue and transmitted from serial buffer 100. Moreover, if core receive logic 110 receives a slave read request packet, then core receive logic 110 will enable core transmit logic 120 to allow the corresponding slave read packets to be read from the queues Q0-Q3 to be transmitted from serial buffer 100.

Core receive logic 110 enables the core transmit logic 120 by activating a transmit clock enable request signal (TX_CLK_EN_REQ=1). In response, clock enable logic 104 activates an enable transmit clock signal (EN_TX_CLK=1), which causes clock generator 105 to start generating (i.e., activate) the transmit clock signal TX_CLK. The active transmit clock signal TX_CLK is provided to core transmit logic 120, transmit timer logic 121 and queues Q0-Q3, thereby enabling these blocks.

Once enabled, the transmit clock signal TX_CLK will stay enabled until the period between consecutive outgoing transactions exceeds a predetermined time period, which is hereinafter referred to as the transmit clock timeout period. After servicing an outgoing transaction, core transmit logic 120 activates a control signal (END_TX_PKT) that indicates the end of the outgoing transaction. Upon detecting that the END_TX_PKT signal has been activated, transmit timer logic 121 starts counting down from a transmit clock timeout value, which defines the transmit clock timeout period. In the described embodiment, the transmit clock timeout period is measured in cycles of the transmit clock signal TX_CLK.

Upon detecting a new outgoing transaction, core transmit logic 120 activates a control signal (START_TX_PKT) that indicates the start of the new outgoing transaction. If the next outgoing transaction is detected (i.e., the START_TX_PKT signal is activated) before transmit timer logic 121 expires, then transmit timer logic 121 is reset. More specifically, transmit timer logic 121 is controlled to start counting down from the transmit clock timeout value after the new outgoing transaction has been serviced (i.e., when the END_TX_PKT signal is activated).

However, if transmit timer logic 121 expires before the next outgoing transaction is detected, then transmit timer logic 121 activates a transmit timeout signal (TX_TIMEOUT=1), which disables the transmit clock signal TX_CLK. More specifically, the activated transmit timeout signal TX_TIMEOUT causes clock enable logic 104 to disable the transmit clock enable signal (EN_TX_CLK=0), which in turn, causes clock generator 105 to stop generating the transmit clock signal TX_CLK. As a result, core transmit logic 120 is returned to its default (disabled) state.

By dynamically enabling and disabling the generation of the receive clock signal RX_CLK and the transmit clock signal TX_CLK in the above-described manner, power consumption is advantageously minimized within serial buffer 100.

The operation of various blocks within serial buffer 100 will now be described in more detail, in accordance with one embodiment of the present invention.

As described above, in order to save power within serial buffer 100, core receive logic 110 is disabled by default. While disabled, core receive logic 110 is unable to service any incoming transactions received by sRIO PHY receive logic 101A. Thus, while core receive logic 110 is disabled, event monitor 102 is used to detect incoming transactions received by sRIO PHY receive logic 101A (and in response, generate a retry request for the incoming transaction and enable the receive clock signal, RX_CLK).

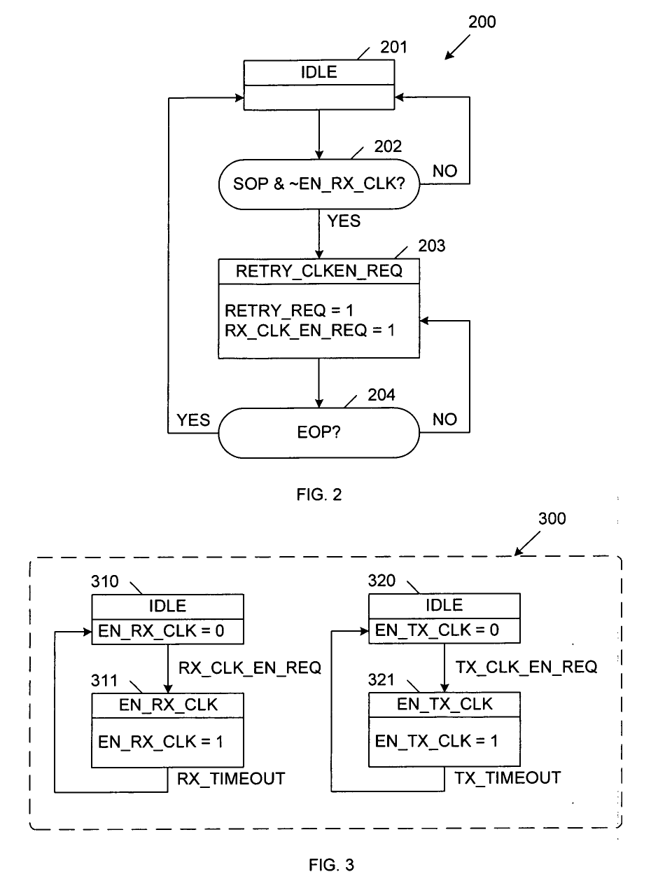

FIG. 2 is a flow diagram 200 illustrating the operation of event monitor 102 in accordance with one embodiment of the present invention. Event monitor 102 is initially in an IDLE state 201. While in IDLE state 201, event monitor 102 monitors the incoming symbols received by sRIO PHY receive logic 101A to detect the presence of any start-of-packet (SOP) control symbol. In accordance with one embodiment of the present invention, the presence of SOP control symbols may be detected by monitoring four differential signal line pairs of sRIO physical layer interface 101 (e.g., rd[3:0] and /rd[3:0]). Event monitor 102 also monitors the status of the enable receive clock signal (EN_RX_CLK), to determine whether the receive clock signal is currently enabled (EN_RX_CLK=1) or disabled (EN_RX_CLK=0).

If event monitor 102 detects a received SOP control symbol and also detects that the receive clock signal RX_CLK is disabled (Step 202, YES branch), then processing transitions to RETRY_CLKEN_REQ state 203. Otherwise (Step 202, NO branch), processing returns to IDLE state 201.

Within RETRY_CLKEN_REQ state 203, event monitor 102 activates the retry request signal (RETRY_REQ=1) and also activates the receive clock enable request signal (RX_CLK_EN_REQ=1). As described above, the activated retry request signal, causes sRIO PHY transmit logic 101B to transmit a packet retry control symbol to the external device. In accordance with one embodiment of the present invention, the packet retry control symbol may be transmitted to the external device using four differential signal line pairs of sRIO physical layer interface 101 (e.g., td[3:0] and /td[3:0]). Also, as described above, the activated receive clock enable request signal (RX_CLK_EN_REQ) causes clock enable logic 104 to activate the enable receive clock signal (EN_RX_CLK=1), which in turn, causes clock generator 105 to start generating the receive clock signal RX_CLK.

While in RETRY_CLKEN_REQ state 203, event monitor 102 monitors the incoming symbols received by sRIO PHY receive logic 101A to detect the presence of an end-of-packet control symbol (EOP). If event monitor 102 detects an end-of-packet control symbol (Step 204, YES branch), then processing returns to IDLE state 201. Otherwise (Step 204, NO branch), processing returns to RETRY_CLKEN_REQ state 203.

FIG. 3 is a flow diagram 300 illustrating the operation of clock enable logic 104 in accordance with one embodiment of the present invention. Note that clock enable logic 104 includes separate, but related, process paths to enable/disable the receive clock signal RX_CLK and the transmit clock signal TX_CLK. Within the process path associated with the receive clock signal RX_CLK, clock enable logic 104 is initially in an IDLE state 310. Similarly, within the process path associated with the transmit clock signal TX_CLK, clock enable logic 104 is initially in an IDLE state 320. When the event monitor 102 activates the receive clock enable request signal (RX_CLK_EN_REQ=1), thereby indicating that a received SOP control symbol has been detected while the receive clock signal RX_CLK is disabled, processing proceeds from IDLE state 310 to EN_RX_CLK state 311, wherein the enable receive clock signal is activated (EN_RX_CLK=1). As described above, clock generator 105 generates the receive clock signal RX_CLK in response to activating the enable receive clock signal, EN_RX_CLK.

If the receive timeout timer subsequently expires (RX_TIMEOUT=1), then processing returns to IDLE state 301, and the enable receive clock signal is deactivated (EN_RX_CLK=0). As described above, deactivating the enable receive clock signal (EN_RX_CLK) causes clock generator 105 to stop generating the receive clock signal RX_CLK.

If core receive logic 110 determines that a response transaction must be returned, or that the water level has reached the water mark in one of the queues Q0-Q3, then core receive logic 110 activates the transmit clock enable request signal (TX_CLK_EN_REQ=1). In response, processing proceeds from IDLE state 320 to EN_TX_CLK state 321, wherein the enable transmit clock signal is activated (EN_TX_CLK=1). As described above, clock generator 105 generates the transmit clock signal TX_CLK in response to the activated enable transmit clock signal EN_TX_CLK.

If the transmit timeout timer subsequently expires (TX_TIMEOUT=1), then processing returns to IDLE state 320, and the enable transmit clock signal is deactivated (EN_TX_CLK=0). As described above, deactivating the enable transmit clock signal (EN_TX_CLK) causes clock generator 105 to stop generating the transmit clock signal TX_CLK.

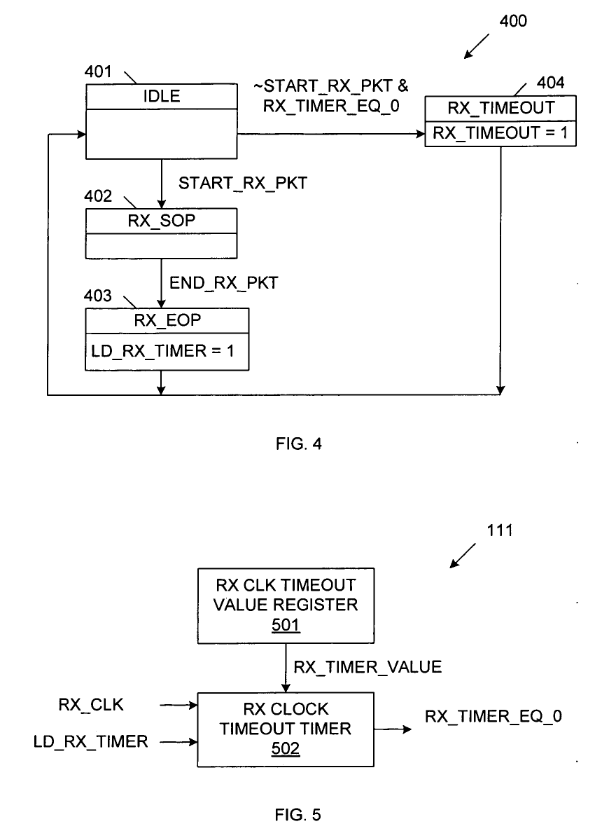

FIG. 4 is a flow diagram 400 illustrating the operation of receive timer logic 111 in accordance with one embodiment of the present invention. FIG. 5 is a block diagram of a portion of receive timer logic 111, which includes receive clock timeout value register 501 and receive clock timeout timer 502.

As described above, receive timer logic 111 determines when to disable the receive clock, RX_CLK. Initially, receive timer logic 111 is in an IDLE state 401. The first time that core receive logic 110 is enabled by the receive clock signal RX_CLK and detects the start of a received packet (START_RX_PKT=1), processing proceeds to RX_SOP state 402. Receive timer logic 111 remains in RX_SOP state 402 until core receive logic 110 detects the end of the received packet (END_RX_PKT=1). At this time, processing proceeds to RX_EOP state 403. Within RX_EOP state 403, receive timer logic 111 activates an internal load receive timer signal (LD_RX_TIMER=1). As illustrated in FIG. 5, this load receive timer signal is applied to receive clock timeout timer 502.

Receive clock timeout timer 502 is also configured to receive a receive clock timeout value (RX_TIMER_VALUE) from receive clock timeout value register 501. When the load receive timer signal is activated (LD_RX_TIMER=1), the receive clock timeout value (RX_TIMER_VALUE) is loaded into receive clock timeout timer 502. At this time, receive clock timeout timer 502 begins counting down from the receive clock timeout value, RX_TIMER_VALUE. In the described embodiment, the receive clock timeout timer 502 counts down in response to the receive clock signal RX_CLK. Thus, the receive clock timeout value RX_TIMER_VALUE specifies the receive clock timeout period (in cycles of the receive clock signal RX_CLK). If the receive clock timeout timer 502 reaches a zero count (before being re-loaded with the receive clock timeout value), receive clock timeout timer 502 asserts a receive timeout control signal (RX_TIMER_EQ_{—}0=1) to indicate that the receive clock timeout period has expired.

Returning now to FIG. 4, after the internal load receive timer signal (LD_RX_TIMER) has been asserted in RX_EOP state 403, processing returns to IDLE state 401. At this time, one of two events will subsequently occur. Either core receive logic 110 will detect the start of the next received packet before receive clock timeout timer 502 expires, or receive clock timeout timer 502 will expire before core receive logic 110 detects the start of the next received packet.

If core receive logic 110 detects the start of the next received packet (START_RX_PKT=1) before the receive clock timeout timer 502 expires, then processing proceeds to RX_SOP state 402. When core receive logic 110 subsequently detects the end of this next received packet (END_RX_PKT=1), processing proceeds to RX_EOP state 403, wherein the LD_RX_TIMER signal is activated to re-load receive clock timeout timer 502 with the receive clock timer value (RX_TIMER_VALUE). Re-loading the receive clock timeout timer 502 in this manner effectively restarts the receive clock timeout period. Note that if the receive clock timeout timer 502 expires while receive timer logic 111 is in RX_SOP state 402, this expiring timer has no effect on the operation of receive timer logic 111, as the receive clock timeout timer 502 is subsequently re-loaded in RX_EOP state 403.

However, if the receive clock timeout timer 502 expires (RX_TIMER_EQ_{—}0=1) before core receive logic 110 detects the start of the next received packet (START_RX_PKT=0), then processing proceeds from IDLE state 401 to RX_TIMEOUT state 404. Within RX_TIMEOUT state 404, receive timer logic 111 activates the receive clock timeout signal (RX_TIMEOUT=1). As described above, receive timer logic 111 provides the receive clock timeout signal RX_TIMEOUT to clock enable logic 104. Upon receiving the activated receive clock timeout signal RX_TIMEOUT, clock enable logic 104 de-activates the enable receive clock signal EN_RX_CLK, thereby causing clock generator 105 to stop generating (i.e., disable) the receive clock signal, RX_CLK. Receive timer logic 111 then returns to the IDLE state 401.

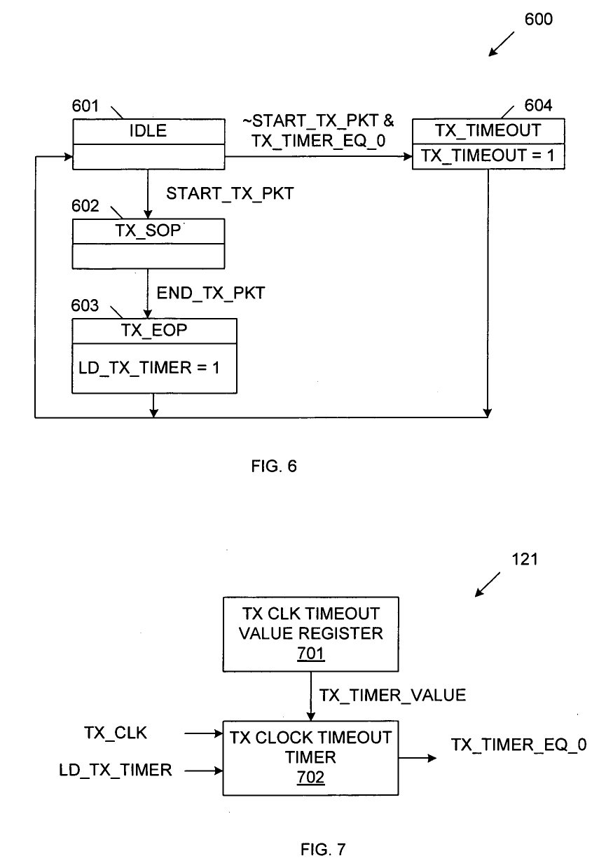

Transmit timer logic 121 operates in a manner similar to receive timer logic 111. FIG. 6 is a flow diagram 600 illustrating the operation of transmit timer logic 121 in accordance with one embodiment of the present invention. FIG. 7 is a block diagram of a portion of transmit timer logic 121, which includes transmit clock timeout value register 701 and transmit clock timeout timer 702.

As described above, transmit timer logic 121 determines when to disable the transmit clock, TX_CLK. Initially, transmit timer logic 121 is in an IDLE state 601. The first time that core transmit logic 120 is enabled by the transmit clock signal TX_CLK and detects the start of a transmitted packet (START_TX_PKT=1), processing proceeds to TX_SOP state 602. Transmit timer logic 121 remains in TX_SOP state 602 until core transmit logic 120 detects the end of the transmitted packet (END_TX_PKT=1). At this time, processing proceeds to TX_EOP state 603. Within TX_EOP state 603, transmit timer logic 121 activates an internal load transmit timer signal (LD_TX_TIMER=1). As illustrated in FIG. 7, this load transmit timer signal is applied to transmit clock timeout timer 702.

Transmit clock timeout timer 702 is also configured to receive a transmit clock timeout value (TX_TIMER_VALUE) from transmit clock timeout value register 701. When the load transmit timer signal is activated (LD_TX_TIMER=1), the transmit clock timeout value (TX_TIMER_VALUE) is loaded into transmit clock timeout timer 702. At this time, transmit clock timeout timer 702 begins counting down from the transmit clock timeout value, TX_TIMER_VALUE. In the described embodiment, the transmit clock timeout timer 702 counts down in response to the transmit clock signal TX_CLK. Thus, the transmit clock timeout value TX_TIMER_VALUE specifies the transmit clock timeout period (in cycles of the transmit clock signal TX_CLK). If the transmit clock timeout timer 702 reaches a zero count (before being re-loaded with the transmit clock timeout value), transmit clock timeout timer 702 asserts a transmit timeout control signal (TX_TIMER_EQ_{—}0=1) to indicate that the transmit clock timeout period has expired.

Returning now to FIG. 6, after the internal load transmit timer signal (LD_TX_TIMER) has been asserted in TX_EOP state 603, processing returns to IDLE state 601. At this time, one of two events will subsequently occur. Either core transmit logic 120 will detect the start of the next transmitted packet before transmit clock timeout timer 702 expires, or transmit clock timeout timer 702 will expire before core transmit logic 120 detects the start of the next transmitted packet.

If core transmit logic 120 detects the start of the next transmitted packet (START_TX_PKT=1) before the transmit clock timeout timer 702 expires, then processing proceeds to TX_SOP state 702. When core transmit logic 120 subsequently detects the end of this next transmitted packet (END_TX_PKT=1), processing proceeds to TX_EOP state 703, wherein the LD_TX_TIMER signal is activated to re-load transmit clock timeout timer 702 with the transmit clock timer value (TX_TIMER_VALUE). Re-loading the transmit clock timeout timer 702 in this manner effectively restarts the transmit clock timeout period. Note that if the transmit clock timeout timer 702 expires while transmit timer logic 111 is in TX_SOP state 602, this expiring timer has no effect on the operation of transmit timer logic 121, as the transmit clock timeout timer 702 is subsequently re-loaded in TX_EOP state 603.

However, if the transmit clock timeout timer 702 expires (TX_TIMER_EQ_{—}0=1) before core transmit logic 120 detects the start of the next transmitted packet (START_TX_PKT=0), then processing proceeds from IDLE state 601 to TX_TIMEOUT state 604. Within TX_TIMEOUT state 604, transmit timer logic 121 activates the transmit clock timeout signal (TX_TIMEOUT=1). As described above, transmit timer logic 121 provides the transmit clock timeout signal TX_TIMEOUT to clock enable logic 104. Upon receiving the activated transmit clock timeout signal TX_TIMEOUT, clock enable logic 104 de-activates the enable transmit clock signal EN_TX_CLK, thereby causing clock generator 105 to stop generating (i.e., disable) the transmit clock signal, TX_CLK. Transmit timer logic 121 then returns to the IDLE state 601.

Although the present invention has been described in connection with various embodiments, it is understood that variations of these embodiments would be obvious to one of ordinary skill in the art. Thus, the present invention is limited only by the following claims.

I claim:

1. A method of operating a serial buffer comprising:
monitoring incoming transactions to detect start-of-packet symbols;
operating core receive logic of the serial buffer in response to a receive clock signal, which is dynamically enabled and disabled; and
enabling the receive clock signal if the receive clock signal is disabled and a start-of-packet symbol is detected in an incoming transaction.

2. The method of claim 1, further comprising disabling the receive clock signal if the receive clock signal is enabled and a receive timeout period elapses between a time that the core receive logic detects an end of a received packet and a time that the core receive logic detects the start of a next received packet.

3. The method of claim 1, wherein the receive clock signal is enabled by causing a clock generator to generate the receive clock signal, and wherein the receive clock signal is disabled by causing the clock generator to stop generating the receive clock signal.

4. The method of claim 1, further comprising transmitting a retry request from the serial buffer if the receive clock signal is disabled and a start-of-packet symbol is detected in an incoming transaction.

5. The method of claim 4, wherein the retry request comprises an sRIO packet retry control symbol.

6. The method of claim 1, further comprising:
operating core transmit logic of the serial buffer in response to a transmit clock signal, which is dynamically enabled and disabled; and
enabling the transmit clock signal if the transmit clock signal is disabled and the core receive logic indicates that outgoing transactions must be transmitted from the serial buffer.

7. The method of claim 6, further comprising disabling the transmit clock signal if the transmit clock signal is enabled and a transmit timeout period elapses between a time that the core transmit logic detects an end of a transmitted packet and a time that the core transmit logic detects the start of a next transmitted packet.

8. The method of claim 6, wherein the transmit clock signal is enabled by causing a clock generator to generate the transmit clock signal, and wherein the transmit clock signal is disabled by causing the clock generator to stop generating the transmit clock signal.

9. The method of claim 1, further comprising disabling the receive clock signal by default.

10. The method of claim 6, further comprising disabling the transmit clock signal by default.

11. A serial buffer comprising:
a physical layer interface configured to receive incoming transactions, wherein the physical layer interface is enabled during normal operation of the serial buffer;
an event monitor coupled to the physical layer interface, and configured to identify start-of-packet symbols in the incoming transactions, wherein the event monitor is enabled during normal operation of the serial buffer;
core receive logic coupled to receive the incoming transactions from the physical layer interface; and
clock enable logic coupled to the event monitor, and configured to dynamically enable and disable a receive clock signal provided to the core receive logic, wherein the receive clock signal, when enabled, enables the core receive logic to process incoming transactions received from the physical layer interface.

12. The serial buffer of claim 11, further comprising core transmit logic coupled to the physical layer interface, wherein the clock enable logic is configured to dynamically enable and disable a transmit clock signal provided to the core transmit logic, wherein the transmit clock signal, when enabled, enables the core transmit logic to control the transmission of outgoing transactions to the physical layer interface.

13. The serial buffer of claim 11, further comprising a receive timer configured to cause the clock enable logic to disable the receive clock signal upon determining that a receive timeout period has expired.

14. A serial buffer comprising:
means for monitoring incoming transactions to detect start-of-packet symbols;
means for disabling a receive clock signal used to operate core receive logic of the serial buffer; and
means for enabling the receive clock signal if the receive clock signal is currently disabled and a start-of-packet symbol is detected in an incoming transaction.

15. The serial buffer of claim 14, wherein the means for disabling the receive clock signal are configured to disable the receive clock signal if the receive clock signal is currently enabled and a receive timeout period elapses between an end of an incoming transaction and a start of a next incoming transaction.

16. The serial buffer of claim 14, wherein the means for enabling the receive clock signal comprise a clock generator configured to generate the receive clock signal.

17. The serial buffer of claim 14, further comprising means for transmitting a retry request from the serial buffer if the receive clock signal is currently disabled and a start-of-packet symbol is detected in an incoming transaction.

18. The serial buffer of claim 14, further comprising:
means for disabling a transmit clock signal used to operate core transmit logic of the serial buffer; and
means for enabling the transmit clock signal if the transmit clock signal is currently disabled and the core receive logic indicates that outgoing transactions must be transmitted from the serial buffer.

19. The method of claim 18, wherein the means for disabling the transmit clock signal are configured to disable the transmit clock signal if the transmit clock signal is currently enabled and a transmit timeout period elapses between an end of an outgoing transaction and a start of a next outgoing transaction.

20. The serial buffer of claim 18, wherein the means for enabling the transmit clock signal comprise a clock generator configured to generate the transmit clock signal.
